(19) United States
(12) Patent Application Publication
(10) Pub. No.: US 2012/0057606 A1
(43) Pub. Date: Mar. 8, 2012

(54) MULTIPLEXER CIRCUIT

(75) Inventors: Delong Cui, Tustin, CA (US); Afshin Momtaz, Laguna Hills, CA (US); Jun Cao, Irvine, CA (US)

(73) Assignee: BROADCOM CORPORATION, Irvine, CA (US)

(21) Appl. No.: 12/880,030

(22) Filed: Sep. 10, 2010

Related U.S. Application Data
(60) Provisional application No. 61/380,657, filed on Sep. 7, 2010.

(51) Int. Cl. H04J 3/06

(52) U.S. Cl. 370/516

(57) ABSTRACT

According to an example embodiment, a circuit may include a first pair of differential input transistors, each coupled between at least an associated first positive clock transistor and ground; the first positive clock transistors coupled between differential output nodes and the differential input transistors associated with the first positive clock transistors, the first positive clock transistors being configured to respond to a positive input from a clock; a first inductor coupled between the differential output nodes and a voltage source; a second pair of differential input transistors, each coupled between at least an associated first negative clock transistor and ground; the first negative clock transistors coupled between the differential output nodes and the differential input transistors associated with the first negative clock transistors, the first negative clock transistors being configured to respond to a negative input from the clock; and the differential output nodes coupled between the first inductor, the first positive clock transistors, and the first negative clock transistors.

### CROSS-REFERENCE TO RELATED APPLICATION

This application claims the benefit of priority based on U.S. Provisional Application No. 61/380,657, filed Sep. 7, 2010, entitled, “Multiplexer Circuit,” the disclosure of which is hereby incorporated by reference.

### TECHNICAL FIELD

This description relates to multiplexers.

### BACKGROUND

In high-speed transmitters, parallel data may pass through a parallel-toserial converter or multiplexer, be retimed, and sent out. Jitter, or deviation in timing from the ideal synchronization between a clock and data, may limit the speed at which data may pass through the multiplexer.

### SUMMARY

The details of one or more implementations are set forth in the accompanying drawings and the description below. Other features will be apparent from the description and drawings, and from the claims.

### BRIEF DESCRIPTION OF THE DRAWINGS

FIG. 1 is a circuit diagram of a multiplexer circuit for reducing jitter according to an example embodiment.

FIG. 2A is a circuit diagram of a differential input multiplexer circuit for reducing jitter according to another example embodiment.

FIG. 2B is a circuit diagram of a differential input multiplexer circuit for reducing jitter according to an example which utilizes shunt-series peaking.

FIG. 2C is a circuit diagram of a differential input multiplexer circuit for reducing jitter according to an example which utilizes T-coil peaking.

FIG. 3 is a block diagram of a clock and data which may be input into any of the multiplexers shown in FIGS. 1 and 2A, 2B, 2C according to an example embodiment.

### DETAILED DESCRIPTION

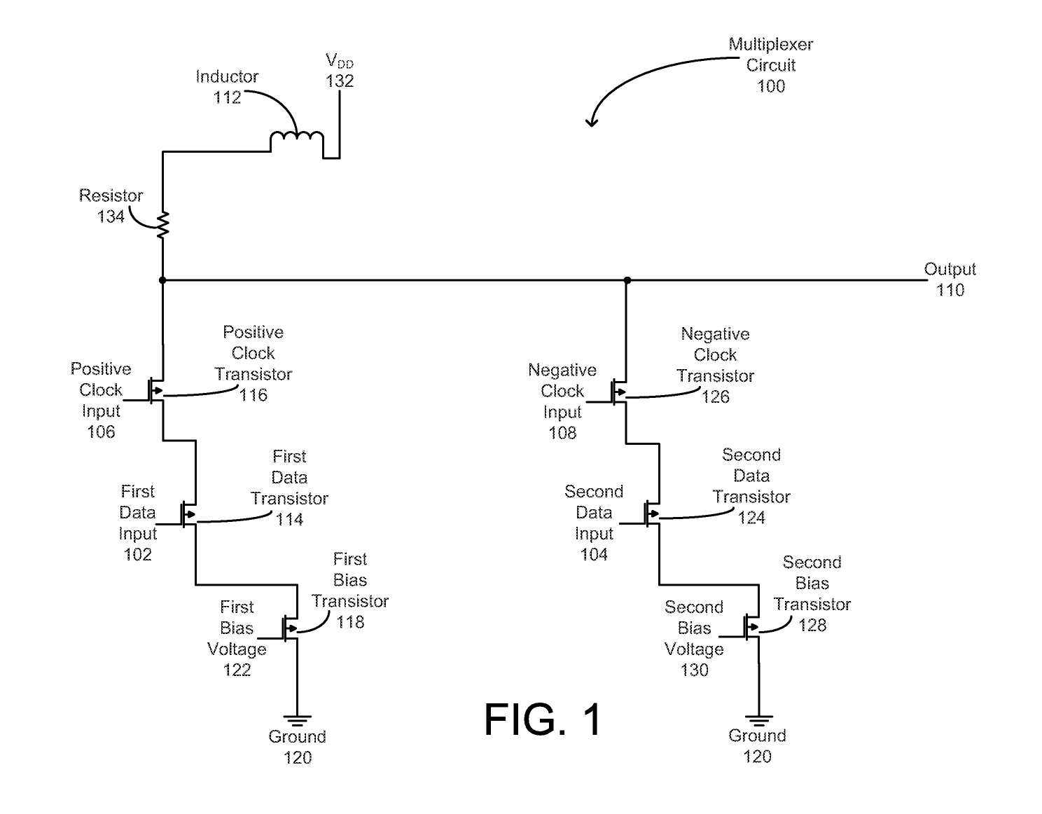

FIG. 1 is a circuit diagram of a multiplexer circuit 100 for reducing jitter according to an example embodiment. The multiplexer circuit 100 may receive a first data input 102 and a second data input 104 in parallel. The data inputs 102, 104 may include any type of signal, such as square waves corresponding to voltage levels, provided concurrently or simultaneously to the multiplexer circuit 100.

The multiplexer circuit 100 may multiplex the data according to a clock signal. The clock signal may alternate between a positive clock input 106 and a negative clock input 108. The clock inputs 106, 108 may respectively include positive and negative signals such as voltage input, or high and low signals such as voltage input, according to example embodiments. The multiplexer circuit 100 may respond to the clock signal by providing a signal to an output node 110 based on the first data input 102 while receiving the positive clock input 106, and providing a signal to the output node 110 based on the second data input 104 while receiving the negative clock input 108.

Some multiplexer circuits may experience capacitive loading at high frequencies, such as data frequencies exceeding 25 Gigabits per second or 50 Gigabits per second, resulting in jitter, signal degradation, and/or loss of signal quality. The multiplexer circuit 100 shown in FIG. 1 may include an inductor 112, which may counter the capacitive effects, reducing the jitter and preserving the signal quality.

The first data input 102 may be provided to a gate of a first data transistor 114. The first data transistor 114 may include, for example, a metal-oxide-semiconductor field-effect transistor (MOSFET) which has a varying resistance level based on the first data input. The first data transistor 114 may be connected to or coupled in series with a positive clock transistor 116, which may also include a MOSFET. The gate of the positive clock transistor 116 may be controlled by the positive clock input 106. The positive clock transistor 116 may be connected or coupled between the first data transistor 114 and the output node 110. Thus, the positive clock transistor 116 may control whether the output node 110 responds to the first data input 102, the multiplexer circuit 100 receiving the first data input 102 via the first data transistor 114.

The multiplexer circuit 100 may also include a first bias transistor 118 connected or coupled between the first data transistor 114 and a ground 120. The first bias transistor 118 may include a MOSFET, and may receive a first bias voltage 122. The first bias voltage 122 may be configured to maintain a constant current through the first bias transistor 118 to ground 120. The configuration of the first bias voltage 122 to maintain a constant current through the first bias transistor 118 may cause the combination of the first bias transistor 118 and the first bias voltage 122 to act as a constant current source, according to an example embodiment.

The multiplexer circuit 100 may also include a second data transistor 124 with a gate controlled by the second data input 104, a negative clock transistor 126 with a gate controlled by the negative clock input 108, and a second bias transistor 128 with a gate controlled by a second bias voltage 130 configured to maintain a constant current through the second bias transistor 128 to ground 120. The transistors 124, 126, 128 may be MOSFETs, and may perform similar functions to the transistors 114, 116, 118; the second data transistor 124 and the negative clock transistor 126 may, in combination, provide a signal to the output node 110 based on the second data input 104 during the negative clock cycle. The negative clock transistor 126 may be coupled to the positive clock input 106 via an inverter, allowing the second data transistor 124 to provide the signal based on the second data input 104 on the opposite clock cycle than the first data transistor 114 and first data input 102.

The multiplexer circuit 100 may include a power source or voltage source (V_{DD}) 132. The voltage source 132 may provide power to the multiplexer circuit 100. The multiplexer circuit 100 may include a resistor 134 coupled or connected between the voltage source 132 and the output node 110.

The first data transistor 114 may act as a switch between the resistor 134 and the constant current source formed by first bias transistor 118 and first bias voltage 122 during the positive clock cycle, causing the voltage level at the output node 110 to be based on the first data input 102 (during the negative clock cycle, the positive clock transistor 116 may function as an open circuit, isolating the first data input 102 from the output node 110). Similarly, the second data transistor 124 may act as a switch between the resistor 134 and the constant current source formed by second bias transistor 128 and second bias voltage 130 during the negative clock cycle, causing the voltage level at the output node 110 to be based on the second data input 104 (during the positive clock cycle, the negative clock transistor 126 may function as an open circuit, isolating the second data input 104 from the output node 110). In both instances, the variable may be the data inputs 102 and 104; thus, during the positive clock cycle, the voltage level at the output node 110 may be based on the resistance of the first data transistor 114, which is a function of the first data input 102, whereas during the negative clock cycle, the voltage level at the output node 110 may be based on the resistance of the second data transistor 124, which is a function of the second data input 104.

The transistors 114, 116, 118, 124, 126, 128 may cumulatively create capacitive loading in the multiplexer circuit 100. The capacitive loading may cause a delayed response to the inputs 102, 104 with respect to their clock cycles, which may prevent the signal from building up sufficiently during a short clock cycle. The inductor 112 may counter the capacitive loading and allow the signals from the inputs 102, 104 to build quickly during their respective clock cycles.

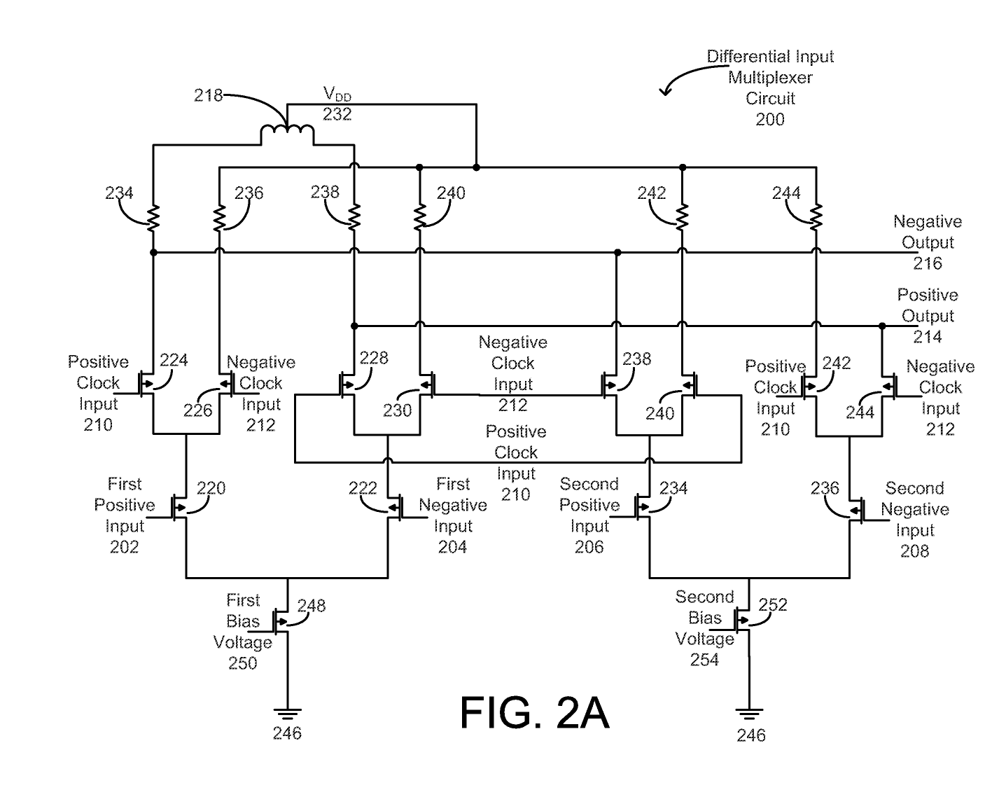

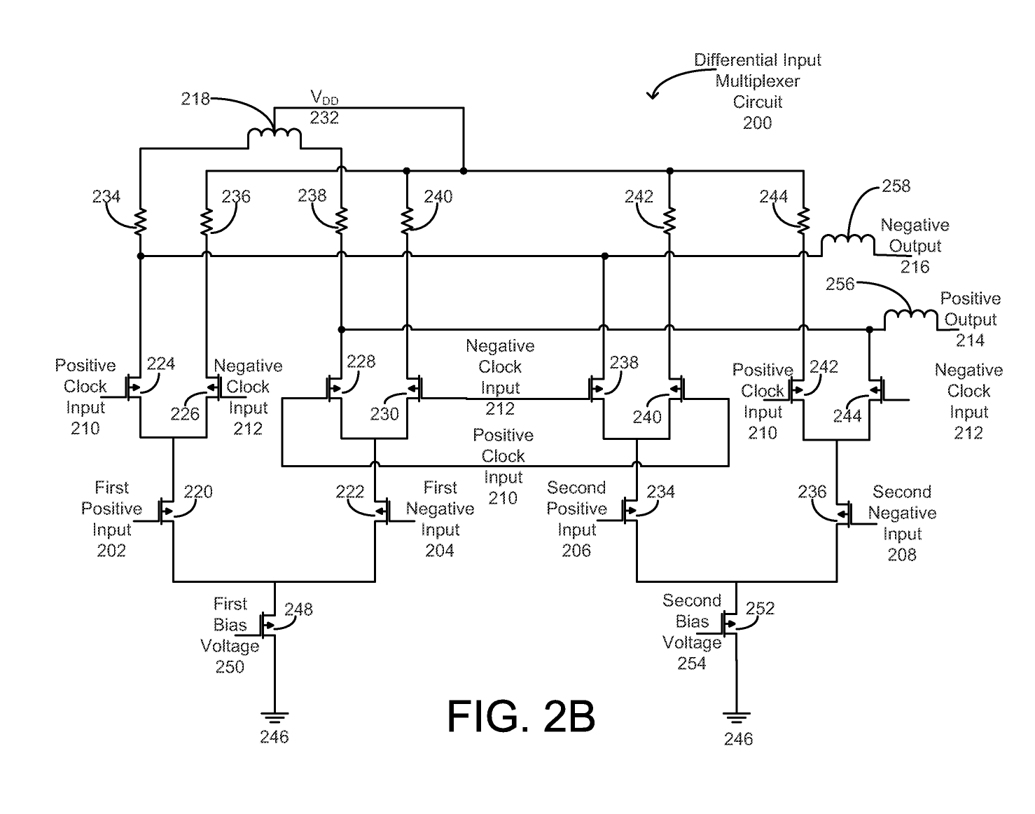

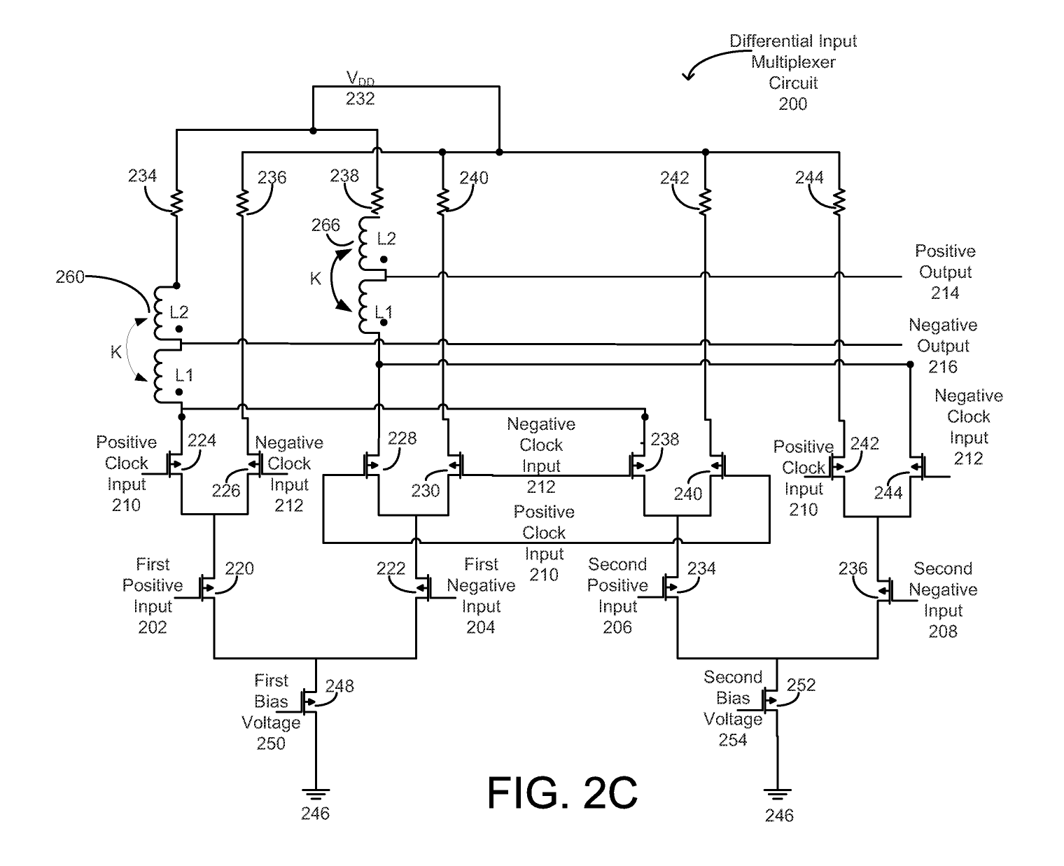

FIG. 2A is a circuit diagram of a differential input multiplexer circuit 200 for reducing jitter according to another example embodiment. The differential input multiplexer circuit 200 functions similarly to the multiplexer circuit 100 by receiving parallel data inputs and serializing, or time-division multiplexing, the inputs to an output. Similarly to the multiplexer circuit 100, the differential input multiplexer circuit 200 includes an inductor which reduces capacitive loading by the transistors, enabling the differential input multiplexer circuit 200 to process data at high speeds, such as data speeds in excess of 25 Gigabits per second or 50 Gigabits per second. However, the differential input multiplexer circuit 200 includes differential inputs, receiving, for each input, a positive and negative input value which are substantially equal in value and opposite in polarity.

The differential input multiplexer circuit 200 may include differential first data inputs 202, 204. The differential first data inputs 202, 204 may include a first positive data input 202 and a first negative data input 204 which are substantially equal in magnitude and opposite in polarity. Similarly, the differential second data inputs 206, 208 may include a second positive data input 206 and a second negative data input 208 which are substantially equal in magnitude and opposite in polarity. The differential input multiplexer circuit 200 may receive a clock signal, which may include a positive clock input 210 and negative clock input 212, as described above with respect to the clock inputs 106, 108 provided to the multiplexer circuit 100.

During the positive clock cycle, the differential input multiplexer circuit 200 may provide differential signals to differential output nodes 214, 216 of the differential input multiplexer circuit 200 based on the differential first data input 202, 204. Similarly, during the negative clock cycle, the differential input multiplexer circuit 200 may provide differential signals to the differential output nodes 214, 216 of the differential input multiplexer circuit 200 based on the differential second data input 206, 208.

As discussed above with respect to the multiplexer circuit 100, transistors, which may be MOSFETs, in the differential input multiplexer circuit 200 may cause capacitive loading, causing jitter and/or degradation of the output signal. The differential input multiplexer circuit 200 may include an inductor 218 to counter or mitigate the capacitive loading, restoring the signal quality.

The first differential data inputs 202, 204 may be coupled or connected to gates of, and/or control, respective first differential input transistors 220, 222. The first differential data inputs 202, 204 may control the resistance of the first differential input transistors 220, 222. Each of the first differential input transistors 220, 222 may in turn be coupled to a pair of differential clock transistors 224, 226, 228, 230.

The first positive input transistor 220 may be coupled to the voltage source 232 via the positive clock transistor 224, a resistor 234, and the inductor 218. The resistor 234 may create certain voltage levels at the negative output node 216. The first negative input transistor 222, controlled by the first negative data input 204, may also be coupled to the voltage source 232 via a positive clock transistor 228, resistor 238, and inductor 218. The resistor 238 may create certain voltage levels at the positive output node 214. The inductor 218 may reduce the capacitive effects of the positive clock transistor 224, 228 and the first differential input data transistors 220, 222.

The positive clock transistor 224 and 228 may allow current to flow through the positive clock transistors and the first differential input data transistors 220 and 222 during the positive clock cycles, but not during the negative clock cycles. The first differential input data transistors 220, 222 may function as differential switches between the negative/positive output nodes 216/214 and the constant current source formed by first bias transistor 248 and first bias voltage 250 during the positive clock cycles, allowing the differential input multiplexer circuit 200 to provide an output signal at the differential output nodes 216 and 214 based on the first differential inputs 202 and 204.

The differential input multiplexer circuit 200 may also include a first bias transistor 248 controlled by a first bias voltage 250. The first bias voltage 250, like the first bias voltage 122 in the multiplexer circuit 100, may be configured to maintain a constant current flowing through the first bias transistor 248, causing the combination of the first bias transistor 248 and first bias voltage to function as a constant current source.

While FIG. 2A shows one inductor 218 in the differential input multiplexer circuit 200, the differential input multiplexer circuit 200 may also include two inductors, with a first inductor coupled between the voltage source 232 and resistor 234 and a second inductor coupled between the voltage source 232 and resistor 238.

The second differential data inputs 206, 208 may be coupled to a similar array of elements as the first differential data inputs 202, 204, provide differential outputs on the negative clock cycles. The second differential data inputs 206, 208 may control gates of second differential input transistors 234, 236. The second differential input transistors 234, 236 may act as differential switches to provide differential data outputs to the differential output nodes 216, 214 based on the second differential inputs 206, 208 during the negative clock cycles.

The second positive input transistor 234 may be coupled to the voltage source 232 via a negative clock transistor 238, the resistor 234, and the inductor 218. The second negative input transistor 236 may be coupled to the voltage source 232 via negative clock transistor 244, the resistor 238, and the inductor 218. Thus, the first positive input transistor 220 may share the resistor 234 and left side of the inductor 218 as a path to the voltage source 232 via positive clock transistor 224 with the second positive input transistor 234 via negative clock input transistor 238. Similarly, the first negative input transistor 222 may share the resistor 238 and right side of the inductor 218 via positive clock transistor 228 as a path to the voltage source 232 with the second negative input transistor 236 via negative clock transistor 244.

The differential input multiplexer circuit 200 may also include a second bias transistor 252 coupled between the second differential transistors 234, 236 and ground 246. The second bias transistor 252, like the first bias transistor 248 and bias transistors 118, 128, may be controlled by a second bias voltage 254 configured to maintain a constant current through the second bias transistor 252.

Because the first differential inputs 202, 204 provide signals to the differential output nodes 216, 214 only during the positive clock cycle, the negative clock transistors 226, 230, which are controlled by the negative clock input 212, may not have paths to and/or be coupled to the outputs 216 and 214. Similarly, because the second differential inputs 206, 208 provide signals to the differential output nodes 214, 216 only during the negative clock cycle, the positive clock transistors 240, 242, which are controlled by the positive clock 210, may not have paths to and/or be coupled to the outputs 216 and 214. Instead, these four transistors 226, 230, 240, 242 may be coupled to each other via resistors 236, 240, 242, 244 or directly via voltage source 232.

While FIG. 2A shows a two-to-one multiplexer which receives two differential data inputs in parallel and serializes the two data inputs, any number of parallel inputs may be received and serialized or multiplexed. The differential multiplexer circuit 200 may, for example, be designed to serialize any number, such as four, eight, or any power of two data inputs.

FIG. 2B is a circuit diagram of a differential input multiplexer circuit 200 for reducing jitter according to an example which utilizes shunt-series peaking. In this example, the differential input multiplexer circuit 200 may include series inductors 256, 258 before each differential output 214 and 216. The series inductor 256 may be coupled between the positive output node 214 and the transistors 228, 224 and resistor 238. The series inductor 258 may be coupled between the negative output node 216 and the transistors 224, 238 and resistor 234. The series inductors 256, 258 may further reduce capacitive loading in the differential input multiplexer circuit 200 and clarify the output signal output at the differential output nodes 214, 216.

FIG. 2C is a circuit diagram of a differential input multiplexer circuit 200 for reducing jitter according to an example which utilizes T-coil peaking. In this example, T-coil inductor 260 may be coupled between the negative output node 216, resistor 234 and the transistors 224, 238. Also in this example, T-coil inductors 266 may be coupled between the positive output node 214, resistor 238 and the transistors 228, 244. The T-coil inductors 260 and 266 further reduce capacitive loading in the differential input multiplexer circuit 200 and clarify the signal output at the differential output nodes 214, 216.

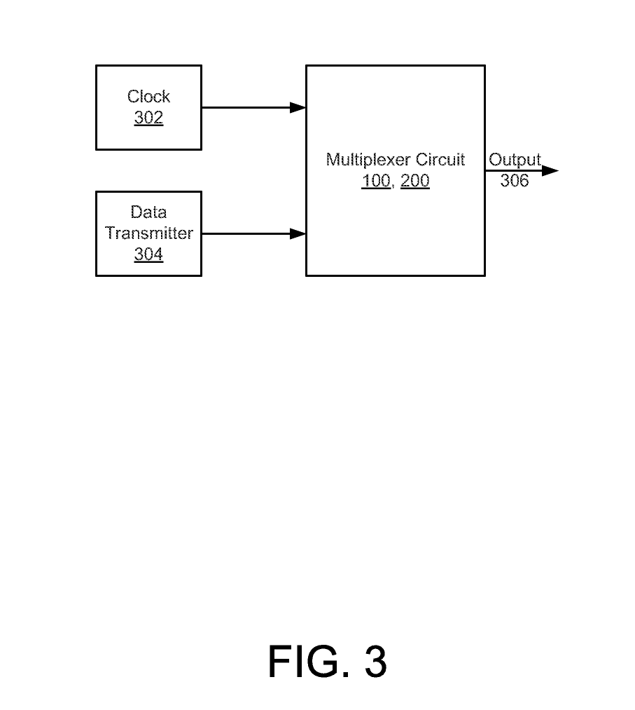

FIG. 3 is a block diagram showing a clock 302 and data transmitter 304 which provide input into either of the multiplexer circuits 100, 200 shown in FIGS. 1 and 2A, 2B, 2C according to an example embodiment. The clock 302 may be a clock which provides alternating clock input signals 106, 108, 210, 212, such as positive and negative or high and low signals (such as ones (1s) and zeroes (0s)), to the multiplexer circuit 100, 200 as described with reference to FIGS. 1 and 2A, 2B, 2C. The clock 302 may, for example, include a voltage controlled oscillator (VCO) configured to maintain a constant frequency. The data transmitter 304 may include a current mode logic (CML) transmitter which provides parallel data input signals, such as the data input signals 102, 104, 202, 204, 206, 208 described with respect to FIGS. 1 and 2A, 2B, 2C. The parallel data signals may be differential as described with reference to FIG. 2A, or single-ended as described with reference to FIG. 1. The multiplexer circuit 100, 200 may provide a single-ended serialized output signal 306 as described with reference to FIG. 1, or a differential serialized output signal as described with reference to FIGS. 2A, 2B, 2C.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A circuit comprising:
a first data transistor coupled between a first positive clock transistor and a ground, the first data transistor being configured to respond to a first data input;
the first positive clock transistor being coupled between the first data transistor and an inductor, the first positive clock transistor being configured to respond to a positive input from a clock;
the inductor coupled between the first positive clock transistor and a voltage source;
a first negative clock transistor coupled between the inductor and a second data transistor, the first negative clock transistor being configured to respond to a negative input from the clock;
the second data transistor coupled between the first negative clock transistor and the ground, the second data transistor being configured to respond to a second data input; and
an output node coupled between the inductor, the first positive clock transistor, and the first negative clock transistor.

2. The circuit of claim 1, further comprising a first resistor coupled between the first positive clock transistor, the first negative clock transistor and the first inductor.

3. The circuit of claim 1, further comprising a first bias transistor coupled between the first data transistor and the ground.

4. The circuit of claim 1, further comprising:
a first bias transistor coupled between the first data transistor and the ground; and
a first bias voltage coupled to the first bias transistor, the first bias voltage being configured to maintain a constant current through the first bias transistor.

5. The circuit of claim 1, further comprising:
a first bias transistor coupled between the first data transistor and the ground;
a first bias voltage coupled to the first bias transistor, the first bias voltage being configured to maintain a constant current through the first bias transistor.
a second bias transistor coupled between the second data transistor and the ground; and
a second bias voltage coupled to the second bias transistor, the second bias voltage being configured to maintain a constant current through the second bias transistor.

6. The circuit of claim 1, further comprising a current mode logic transmitter configured to provide the first data input to the first data transistor and the second data input to the second data transistor.

7. The circuit of claim 1, further comprising the clock configured to periodically provide the positive input to the positive clock transistor and the negative input to the negative clock transistor in an alternating sequence.

8. The circuit of claim 1, further comprising a voltage controlled oscillator configured to provide the positive input to the first positive clock transistor and the negative input to the first negative clock transistor.

9. A circuit comprising:
a first pair of differential input transistors, each coupled between at least an associated first positive clock transistor and ground;
the first positive clock transistors coupled between differential output nodes and the differential input transistors associated with the first positive clock transistors, the first positive clock transistors being configured to respond to a positive input from a clock;
a first inductor coupled between the differential output nodes and a voltage source;
a second pair of differential input transistors, each coupled between at least an associated first negative clock transistor and ground;
the first negative clock transistors coupled between the differential output nodes and the differential input transistors associated with the first negative clock transistors, the first negative clock transistors being configured to respond to a negative input from the clock; and
the differential output nodes coupled between the first inductor, the first positive clock transistors, and the first negative clock transistors.

10. The circuit of claim 9, further comprising resistors coupled between the first inductor and each of the differential output nodes.

11. The circuit of claim 9, further comprising:
a second inductor coupled between a positive output node of the differential output nodes and the positive clock transistor coupled to a negative input transistor of the first pair of differential input transistors and the negative clock transistor coupled to a negative input transistor of the second pair of differential input transistors;
a third inductor coupled between a negative output node of the differential output node and the positive clock transistor coupled to a positive input transistor of the first pair of differential input transistors and the negative clock transistor coupled to a positive input transistor of the second pair of differential input transistors.

12. The circuit of claim 9, further comprising:
a T-coil inductor coupled between a positive output node of the differential output nodes and the positive clock transistor coupled to a negative input transistor of the first pair of differential input transistors and the negative clock transistor coupled to a negative input transistor of the second pair of differential input transistors; and
a second T-coil inductor coupled between a negative output node of the differential output nodes and the positive clock transistor coupled to a positive input transistor of the first pair of differential input transistors and the negative clock transistor coupled to a positive input transistor of the second pair of differential input transistors.

13. The circuit of claim 9, further comprising:
a first bias transistor coupled between the first pair of differential input transistors and ground; and
a second bias transistor coupled between the second pair of differential input transistors and the ground.

14. The circuit of claim 9, further comprising:
a first bias transistor coupled between the first pair of differential input transistors and ground; and
a first bias voltage coupled to the first bias transistor, the first bias voltage being configured to maintain a constant current through the first bias transistor;
a second bias transistor coupled between the second pair of differential input transistors and the ground;
a second bias voltage coupled to the second bias transistor, the second bias voltage being configured to maintain a constant current through the second bias transistor.

15. The circuit of claim 9, further comprising a current mode logic transmitter configured to provide the first data input to the first data transistor and the second data input to the second data transistor.

16. The circuit of claim 9, further comprising the clock configured to periodically provide the positive input to the positive clock transistor and the negative input to the negative clock transistor in an alternating sequence.

17. The circuit of claim 9, further comprising a voltage controlled oscillator configured to provide the positive input to the first positive clock transistor and the negative input to the first negative clock transistor.

18. The circuit of claim 9, further comprising:
second negative clock transistors coupled to each of the first differential input transistors, the second negative clock transistors being configured to respond to the negative input from the clock;
second positive clock transistors coupled to each of the second differential input transistors, the second positive clock transistors being configured to respond to the positive input from the clock;
wherein the second negative clock transistors and the second positive clock transistors are coupled to each other directly through a voltage source.

19. The circuit of claim 9, further comprising:
second negative clock transistors coupled to each of the first differential input transistors, the second negative clock transistors being configured to respond to the negative input from the clock;
second positive clock transistors coupled to each of the second differential input transistors, the second positive clock transistors being configured to respond to the positive input from the clock;
wherein the second negative clock transistors and the second positive clock transistors are coupled to each other via a resistor associated with each of the second negative clock transistors and second positive clock transistors.

20. A circuit comprising:
a first positive input transistor coupled between a first differential pair of clock transistors and ground, the first positive input transistor being configured to respond to a first positive input;
the first differential pair of clock transistors including a first positive clock transistor configured to respond to a positive clock input and a first negative clock transistor configured to respond to a negative clock input, the first positive clock transistor being coupled to a negative output node and an inductor;
the inductor coupled between the first positive clock transistor and a voltage source;
a first negative input transistor coupled between a second differential pair of clock transistors and the ground, the first negative input transistor being configured to respond to a first negative input;
the second differential pair of clock transistors including a second positive clock transistor configured to respond to the positive clock input and a second negative clock transistor configured to respond to the negative clock input, the second positive clock transistor being coupled to a positive output node and the inductor;
the differential output nodes including the positive output node and the negative output node;
a second positive input transistor coupled between a third differential pair of clock transistors and ground, the second positive input transistor being configured to respond to a second positive input;
the third differential pair of clock transistors including a third positive clock configured to respond to the positive clock input and a third negative clock transistor configured to respond to a negative clock input, the third negative clock transistor being coupled to the inductor;
a second negative input transistor coupled between a fourth differential pair of clock transistors and ground, the second negative input transistor being configured to respond to a second negative input; and
the fourth differential pair of clock transistors including a fourth positive clock transistor configured to respond to the positive clock input and a fourth negative clock transistor configured to respond to the negative clock input, the fourth negative clock transistor being coupled to the inductor;
wherein the first negative clock transistor, second negative clock transistor, third positive clock transistor, and fourth positive clock transistor are coupled to each other via resistors or directly through a voltage source.
